(19) United States
(12) Patent Application Publication
(10) Pub. No.: US 2008/0018480 A1
(43) Pub. Date: Jan. 24, 2008

(54) Remote body temperature monitoring device

(76) Inventor: John C.K. Sham, Hong Kong (HK)

Correspondence Address: Peter S. Canelias;Law Offices of Peter S. Canelias, Suite 2148, 420 Lexington Avenue, New York, NY, 10170, US

(21) Appl. No.: 11/489,973

(22) Filed: Jul. 20, 2006

(51) Int. Cl. G08B 23/00

(52) U.S. Cl. 340/573.1; 600/474

(57) ABSTRACT

The invention relates to an apparatus for monitoring the body temperature of a subject and to provide an alert locally or remotely to a third party if the bodily temperature of the subject is determined to be abnormal. The device preferably employs infra-red (IR) radiation to remotely measure the temperature of the subject without contact with the subject's skin. The alert system is preferably configured to transmit an alert to a selected third party via a conventional telephone line (plain ordinary telephone service or POTS) or through a wireless mobile communication system. The subjects in the preferred embodiment are infants and young children, seniors, invalids and others who are otherwise confined to a circumscribed area for health reasons.

### BACKGROUND OF THE INVENTION

1. Field of the Invention

The invention relates to an apparatus for monitoring the body temperature of a subject and to provide an alert locally or remotely to a third party if the bodily temperature of the subject is determined to be abnormal. The device preferably employs infra-red (IR) radiation to remotely measure the temperature of the subject without physical contact with the subject's skin. The alert system is preferably configured to transmit an alert to a selected third party via a conventional telephone line (plain ordinary telephone system or POTS) or through a wireless mobile communication system. The subjects in the preferred embodiment are infants and young children, seniors, invalids and others who are otherwise confined to a circumscribed area for health reasons.

2. Description of Related Art

Temperature monitoring devices are well known and in common use worldwide. In general, such devices usually depend upon some form of body contact in order to measure the temperature of a human subject, whether placed within a body orifice or by contact with the skin of the subject. Although such devices are useful, they suffer from the drawback of being unable to measure body temperature remotely and without the direct participation of the human subject.

Remote monitoring of physical conditions is becoming more necessary as an adjunct to home care and supervision for the elderly, and also for infants and small children, who typically may not be able to actively participate in the monitoring. Various methods have been developed for remote patient monitoring, usually in conjunction with hospital or other health care personnel. For example, U.S. Pat. No. 5,544,649 to David et al. discloses a complex facility for in-home monitoring of ambulatory patients wherein the patient is monitored by a health care worker at a central station, while the patient is at a remote location. Various medical condition sensing and monitoring equipment are placed in the patient's home, depending on the particular medical needs of the patient. The patient's medical condition is measured or sensed in the home and the resulting data is transmitted to the central station for analysis and display. The health care worker then is placed into interactive visual communication with the patient concerning the patient's general well being, as well as the patient's medical condition, enabling the health care worker to make “home visits” electronically, twenty-four hours a day. The David et al. system is designed to monitor many body conditions. However, it uses plain contact sensors for measuring the body temperature of the subject.

There have been attempts at remote thermal imaging of a subject, usually in conjunction with facial recognition systems such as that disclosed in U.S. Pat. No. 6,173,068 to Prokoski. In U.S. Pat. No. 6,993,378 to Wiederhold et al., the disclosure shows the use of remote infrared temperature detection within a system of identification. The system of Wiederhold et al. is adapted for measuring the temperature about the nose area as a physiological characteristic pertinent to identification and subsequent verification of identity, and requires that the subject submit to monitoring by positioning himself in the narrow range of the temperature sensor and other identity-verification mechanisms.

The prior art systems do not provide for a simple device for remote, non-contact monitoring of a subject's body temperature, comparing the temperature to a preset value or range, and alerting a designated recipient by an alert when the measured temperature is outside of the range of acceptable body temperature values.

### BRIEF SUMMARY OF THE INVENTION

The present invention combines the benefits of non-contact body temperature monitoring and a programmable remote alert system for changes in bodily temperature that are outside of a predetermined range of temperatures. In its preferred form, the device uses IR radiation to detect the skin temperature of a subject and extrapolate the approximate bodily temperature of the subject. If the measured temperature is outside the preset normal or expected range of temperatures, then an alert is sent to a designated person or phone number either via a POTS line or by wireless communication, cellular phone network, Internet connection, Voice Over Internet Protocol (VoIP) or other telephony means. The message itself may be auditory (voice or simulated voice or an audible alarm such as a buzzer or bell ring), in text message format, or in vibrate mode for a portable communication devices such as a cellular telephone, or any combination of the foregoing. The alert message may also comprise visual display images either alone or in combination with the audio, text message or vibration message.

Another mode of operation for the invention is to continuously monitor and record the subject's temperature where no preset upper and lower temperatures have been entered, or if the user does not need to alert a third party. If no third party notification is needed, then an alert may be provided locally or not at all, depending on the desires of the user.

A preferred embodiment of the device is comprised of two parts; an IR sensing device and a telecommunication terminal. The IR sensor preferably comprises a motion sensing detector, preferably a Passive Infrared (PIR) sensor, an IR temperature sensor, and a data transmission circuit. The PIR sensor is a motion sensing device which is used to detect the presence of the subject within a prescribed area, and to activate the IR temperature sensor. Other means may be employed to detect the presence of a subject, such as a CMOS (complementary metal-oxide semiconductor) image sensor or a far-infrared sensor.

The IR temperature sensor, a preferred form of a non-contact temperature sensing device (and means for measuring body temperature) is used to detect the temperature about the skin or the ambient temperature immediately surrounding the subject. When the subject's body temperature is measured by the device, the data transmission circuit or unit will transmit the temperature reading to the telecommunication terminal. The terminal unit will perform a comparison of the temperature reading to a pre-set temperature or temperature range or ranges, and determine if an alert message is justified. If yes, the telecommunication terminal will transmit an alert message to a selected person through a telephone line or via wireless communication.

The telecommunication terminal comprises a receiver to receive a signal from the data transmission device, a display, and a keypad to input messages and selected telephone numbers. In one preferred form, the apparatus is provided with a pre-recorded message capability for the user to select, but is also provided with recording capability to record customized messages in text or voice format to provide an alert. Telephone numbers for alert contacts are user-inputted prior to use of the apparatus.

Once a signal, including preferably the subject's temperature reading is received from the IR sensor device, the terminal will compare the reading with a default temperature value or to one or more user-inputted and stored preset temperature thresholds or ranges. If the received signal contains a current temperature reading that is out of the range prescribed by the stored temperature values or values, the device will automatically dial or otherwise access a telephone number that has the highest priority assigned to that number, and send the selected message to the identified person once connection is made. If a connection cannot be made to the highest priority telephone number, the device will re-try the number several times, and then start to dial or otherwise access the next lower priority telephone number(s), repeating the process until an adequate connection is made and the message can be sent.

In another embodiment, an optional microphone is provided for the user to record voice messages. The device combines a compact, remote body temperature sensing unit with a communication system in one convenient, portable unit.

Other objects and advantages will be more fully apparent from the following disclosure and appended claims.

### BRIEF DESCRIPTION OF THE DRAWINGS

The above-mentioned and other features and objects of this invention and the manner of obtaining them will become apparent and the invention itself will be best understood by reference to the following description of an embodiment of the invention taken in conjunction with the accompanying drawings, wherein:

FIG. 1 is perspective drawing of a preferred embodiment of the invention showing the components in wired engagement;

FIG. 2 is perspective drawing of a preferred embodiment of the invention showing the components in wireless engagement;

FIG. 3 is a schematic diagram of a preferred embodiment of the invention.

### DETAILED DESCRIPTION

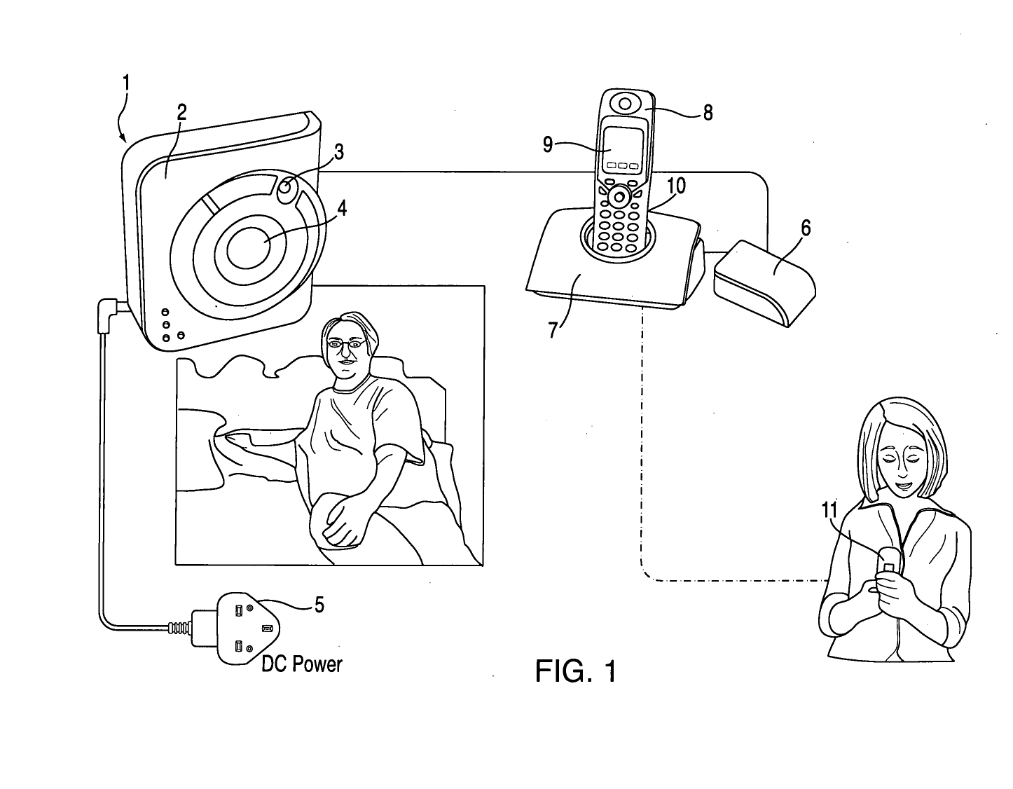

A preferred embodiment of the invention comprises two units; a temperature sensing unit and a temperature information receiving unit, the later being in operable communication with a telephone connection for transmission of an alert or alarm. The first preferred embodiment can best be understood by reference to the drawings. FIG. 1 shows a perspective view of the units in wired operable engagement with each other. The temperature sensing device 1 is partially enclosed by a housing, preferably a plastic shell, with a front face portion 2 that comprises a transmitter and receiver for directional transmission and reception of IR signals. The IR beam is transmitted through opening 3 and the returning signal with body temperature information is received by the detection portion 4. The temperature sensing device is preferably connected to a direct current (DC) power supply 5 to enable continuous operation of the unit in the event of an interruption of a household alternating current (AC) power supply.

The temperature sensing device 1 enables non-contact measurement of the temperature of a human subject's body by reflection of the IR sensor off of the subject's skin or the ambient air immediately proximate to the subject's skin. The IR sensor is a means for non-contact measurement of a body temperature. The temperature can be measured when the front face portion 2 is turned in the direction of the subject and preferably where the subject is within a range of two meters of the front face portion 2. The temperature sensing device 1 can measure body temperature accurately within one-tenth of a degree Centigrade, depending on the distance of the subject from the front face portion 2. The device is preferably equipped with a motion sensing device which is used to detect the presence of the subject within a prescribed area, and to activate the IR temperature sensor.

To function with a telecommunication network, the temperature sensing device 1 is operably connected or linked to a temperature information receiving device 6 so that the temperature measurement may be communicated to the temperature information receiving device 6. The connection or link may be wired or wireless, as is well known to those skilled in the art. The temperature information receiving device 6 can be connected to a POTS line (or cellular line) to transmit signals (alert or alarm) to a stored phone number or other specific user indicator such as an IP address. The phone numbers or other indicators are stored within temperature information receiving device 6, which is operably connected with a telephone network via base unit 7 which holds a typical wireless phone 8. The telephone 8 and base 7 are branded as Panasonic, but any phone will work with the present invention.

The combination of temperature information receiving device 6 and the base 7 and phone unit 8 allows the use of the handset 8 and its attendant display 9 and keypad 10 to input selected telephone numbers and messages. Alternatively, the temperature information receiving device 6 may be provided with a display (preferably LCD) and a keypad to input and view numbers and text messages directly into the temperature information receiving device 6 without utilizing the telephone handset 8. The added display and keypad may be separate units or incorporated within the housing of the temperature information receiving device 6 and may optionally incorporate a microphone for the user to record voice messages. In another preferred form, the apparatus is provided with a pre-recorded message capability for the user to select, but is also provided with recording capability to record customized messages in text or voice format to provide an alert. Telephone numbers for alert contacts are user-inputted prior to use of the apparatus.

Once a signal with a temperature reading is received from the temperature sensing device 1, the temperature information receiving device 6 will compare the reading with a default temperature value or to one or more user-inputted and stored preset temperature thresholds or ranges, preferably stored within the temperature information receiving device 6. For example, a single temperature value may delineate two ranges; one above (higher) than the stored temperature value, and another range below the stored value. Storing two temperature values will create three temperature ranges; one above the higher value, one between the lower and higher value, and one below the higher value. These ranges can be preset according to the subject's needs. If the received signal contains a current temperature reading that is out of the range of the stored temperature value or values, the device will automatically dial or otherwise access a telephone number that has the highest priority assigned to that number, and send the selected message to the identified person's telephone or communication device 11 once a connection is made. If a connection cannot be made to the highest priority telephone number, the device will re-try the number several times, and then start to dial or otherwise access the next lower priority telephone number(s), repeating the process until an adequate connection is made and the message can be sent.

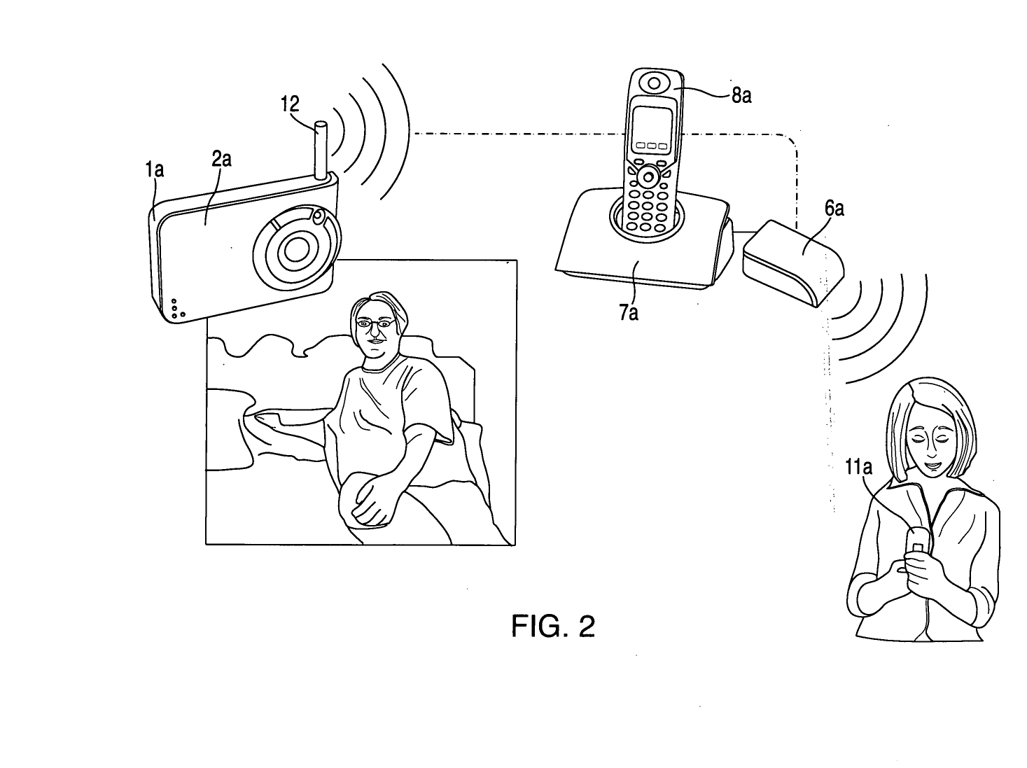

FIG. 2 shows a preferred embodiment of the invention using wireless connections between the temperature sensing device 1a, the temperature information receiving device 6a, the base unit 7a and handset 8a, and the remote alert receiving unit 11 a. The temperature sensing device 1a is preferably equipped with a transmission unit having an external antenna 12 for wirelessly transmitting the temperature measurements to the temperature information receiving device 6a.

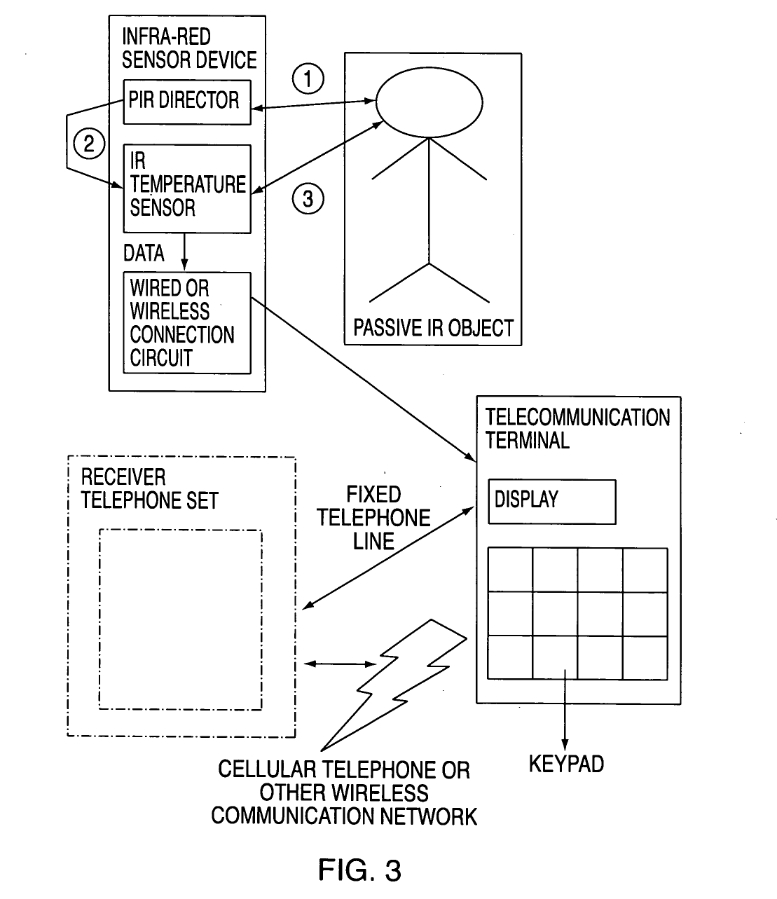

FIG. 3 shows a schematic of the operation of a preferred embodiment of the invention, where the temperature sensing device has a PIR motion detector and an IR temperature sensor, where the IR signals are reflected or bounced off of a passive subject within operable range of the device. The temperature sensing device also has means for conveying the temperature data via a wired or wireless connection circuit to the telecommunication terminal, which incorporates a display and keypad for inputting messages and numbers. The telecommunication terminal accesses a POTS line or a cellular telephone line or other wireless communication network for transmission of an alert to a receiving telephone set.

When a subject passes within range of the temperature sensing device 1 and the measured body temperature is outside of a stored reference temperature range (either higher or lower), the alarm function is initiated, assuming that the alarm function is armed. A user can vary the stored reference temperature range, which is preferably stored in a memory storage device such a flash memory, disk, random access memory (RAM) and other memory storage devices, fixed or removable, well known to those skilled in the art. The memory is associated with the temperature information receiving device 6 or 6a, and is preferably but not necessarily contained within the housing of the temperature information receiving device, as is also well known in the art. It should be noted that in this embodiment the unit is activated by a sensor (motion sensor or image sensor or the like). However, the sensor-activation can be de-activated or not present at all in the device, in which case the unit would be activated and de-activated preferably by means of an auto-switch.

When the subject's body temperature is measured by the device, the data transmission circuit or unit will transmit the temperature reading to the telecommunication terminal. The terminal unit will perform a comparison of the temperature reading to a pre-set temperature or temperature range, and determine if an alert message is justified. If yes, the telecommunication terminal will transmit an alert message to a selected person through a telephone line or via wireless communication. Text messages are outputted to a phone display associated with the receiving unit. The invention will work with open units, sometimes referred to as “brick” type phones, with PDAs, and with clamshell type housings where the upper and lower portions are hingeably attached for opening and closing the device, with the display screen ordinarily housed on the inside surface of the upper or top portion of the clamshell and with the keypad located on the inside surface of the lower or bottom portion.

Since other modifications or changes will be apparent to those skilled in the art, there have been described above the principles of this invention in connection with specific apparatus, it is to be clearly understood that this description is made only by way of example and not as a limitation to the scope of the invention.

What is claimed is:

1. A body temperature sensing and communication device, comprising:
a temperature sensing device having a temperature signal transmitter and a temperature signal receiver;
the temperature signal transmitter transmitting a signal for measuring a temperature of a subject without physical contact with the subject;
the temperature sensing device having a second signal transmitter for transmitting the temperature measurement to a temperature information receiver;
the temperature information receiver being associated with a memory storage for storing the temperature measurement;
the memory storage configured to store a temperature value for comparison with the temperature measurement.

2. The body temperature sensing and communication device according to claim 1, the temperature sensing device further comprising a motion detector for detecting a movement of the subject within a proximate distance from the temperature sensing device.

3. The body temperature sensing and communication device according to claim 2, wherein the motion detector comprises an infrared motion sensor.

4. The body temperature sensing and communication device according to claim 2, wherein the motion detector comprises a complementary metal-oxide semiconductor image sensor.

5. The body temperature sensing and communication device according to claim 1, wherein the temperature signal transmitter is an infrared signal transmitter and the temperature signal receiver is an infrared signal receiver.

6. A body temperature sensing and communication device, comprising:
a temperature sensing device having a temperature signal transmitter and a temperature signal receiver;
the temperature signal transmitter transmitting a signal for measuring a temperature of a subject without physical contact with the subject;
the temperature sensing device having a second signal transmitter for transmitting the temperature measurement to a temperature information receiver;
the temperature information receiver having a stored temperature value for comparison with the temperature measurement, and having a stored transmission destination for transmitting an alert.

7. The body temperature sensing and communication device according to claim 6, the temperature sensing device further comprising a motion detector for detecting a movement of the subject within a proximate distance from the temperature sensing device.

8. The body temperature sensing and communication device according to claim 7, wherein the motion detector comprises an infrared motion sensor.

9. The body temperature sensing and communication device according to claim 7, wherein the motion detector comprises a complementary metal-oxide semiconductor image sensor.

10. The body temperature sensing and communication device according to claim 6, wherein the temperature signal transmitter is an infrared signal transmitter and the temperature signal receiver is an infrared signal receiver.

11. The body temperature sensing and communication device according to claim 6, wherein the stored transmission destination is a telephone number.

12. A body temperature sensing and communication device, comprising:
a temperature sensing device having a temperature signal transmitter and a temperature signal receiver;
the temperature signal transmitter transmitting a signal for measuring a temperature of a subject without physical contact with the subject;
a sensor for detecting a presence of the subject and activating the temperature signal transmitter;
the temperature sensing device having a second signal transmitter for transmitting the temperature measurement to a temperature information receiver;
the temperature information receiver having a stored temperature value for comparison with the temperature measurement, and having a stored transmission destination for transmitting an alert.

13. The body temperature sensing and communication device according to claim 12, wherein the sensor for detecting a presence of the subject comprises an infrared motion sensor.

14. The body temperature sensing and communication device according to claim 12, wherein the sensor for detecting a presence of the subject comprises a complementary metal-oxide semiconductor image sensor.

15. The body temperature sensing and communication device according to claim 12, wherein the temperature signal transmitter is an infrared signal transmitter and the temperature signal receiver is an infrared signal receiver.

16. The body temperature sensing and communication device according to claim 12, wherein the stored transmission destination is a telephone number.

17. A body temperature sensing and communication device, comprising:
a means for measuring a body temperature of a subject without physical contact with the subject;
a means for conveying a measured body temperature to a temperature information receiver;
the temperature information receiver having a stored temperature value for comparison with the measured body temperature, and having a stored transmission destination for transmitting an alert.
